(19) United States
(12) Patent Application Publication
(10) Pub. No.: US 2026/0346789 A1
(43) Pub. Date: Nov. 5, 2026

(54) VEHICLE-USE IMAGE DISPLAY DEVICE

(71) Applicant: SUBARU CORPORATION, Tokyo (JP)

(72) Inventor: Koki MATSUMOTO, Tokyo (JP)

(21) Appl. No.: 19/124,589

(22) PCT Filed: Sep. 20, 2023
(86) PCT No.: PCT/JP2023/034132

§ 371 Date: Apr. 25, 2025

(51) Int. Cl. B60R 1/27; G06F 3/14

(52) U.S. Cl. CPC B60R 1/27; G06F 3/14; B60R 2300/70

(57) ABSTRACT

An image display control unit has a first display control mode when rough-road travel support control is deselected and a second display control mode when the rough-road travel support control is executed. While the first display control mode is executed, the image display control unit stops displaying a surrounding image when a vehicle speed of a vehicle has become equal to or higher than a first threshold. While the second display control mode is executed, the image display controller temporarily stops displaying the surrounding image when the vehicle speed has become equal to or higher than the first threshold, and resumes displaying the surrounding image, which has been temporarily stopped, when the vehicle speed has become lower than a second threshold that is smaller than the first threshold.

### TECHNICAL FIELD

The present invention relates to a vehicle-use image display device having a function of capturing an image of the surroundings of a vehicle and causing a display in the vehicle to display the image.

### BACKGROUND ART

Conventionally, a vehicle such as an automobile is provided with multiple vehicle-mounted cameras that capture images of the surroundings of the vehicle. The images captured by these vehicle-mounted cameras are displayed under control of an image display control unit.

For example, when the vehicle travels at a low speed lower than a set vehicle speed (for example, 20 km/h) and when a driver who drives the vehicle has operated an image display switch or the like, the image display control unit activates the vehicle-mounted camera for an area that is a blind spot of the driver. Then, the image display control unit causes an information display or the like installed in the vehicle to display the captured image.

Such display of the surrounding image is effective when the vehicle travels on a narrow road or is parked, and also when the vehicle travels on a rough road. For example, Japanese Unexamined Patent Application Publication No. 2022-101979 discloses a technique of generating a composite image to be displayed when the vehicle travels on a rough road, the image being unlikely to give a sense of discomfort to the driver.

The image display control unit generally displays a captured image when the vehicle speed of the traveling vehicle is in a low speed range (for example, lower than 20 km/h). That is, when the vehicle speed reaches the set vehicle speed (for example, 20 km/h), the image display control unit automatically stops the image that has been displayed until then.

However, when the vehicle travels on a rough road, the driver changes the vehicle speed depending on the road surface state. In the road surface state in which the driver changes the vehicle speed, the image display control unit automatically stops displaying the image every time the vehicle speed becomes equal to or higher than the set vehicle speed. Thus, the image display switch may be operated many times until the vehicle gets out of the rough road, and the operation of the driver is complicated.

The present invention has been made in view of the above-described circumstances, and it is an object of the present invention to provide a vehicle-use image display device that can provide convenience and safety even in a case where the vehicle speed changes when the vehicle travels on a rough road.

### SUMMARY OF INVENTION

### Solution to Problem

According to an aspect of the present invention, a vehicle-use image display device is applied to a vehicle capable of executing rough-road travel support control by one or both of driving-force distribution control on wheels and braking-force distribution control on the wheels. The vehicle-use image display device includes an image-capturing unit configured to capture a surrounding image of surroundings of the vehicle; an image display configured to display the surrounding image captured by the image-capturing unit; an image display switch configured to instruct displaying the surrounding image; and an image display controller configured to cause the image display to display the surrounding image when the image display switch has been turned on. The image display controller has, as a display control mode, a first display control mode when the rough-road travel support control is deselected and a second display control mode when the rough-road travel support control is executed. The image display controller is configured to, while the first display control mode is executed, stop displaying the surrounding image when a vehicle speed of the vehicle has become equal to or higher than a first threshold. The image display controller is configured to, while the second display control mode is executed, temporarily stop displaying the surrounding image when the vehicle speed has become equal to or higher than the first threshold, and resume displaying the surrounding image, which has been temporarily stopped, when the vehicle speed has become lower than a second threshold that is smaller than the first threshold.

According to another aspect of the present invention, a vehicle-use image display device is applied to a vehicle capable of executing rough-road travel support control by one or both of driving-force distribution control on wheels and braking-force distribution control on the wheels. The vehicle-use image display device includes an image-capturing module configured to capture a surrounding image of surroundings of the vehicle; an image display module configured to display the surrounding image captured by the image-capturing module; an image display switch configured to instruct displaying the surrounding image; and a processor configured to cause the image display module to display the surrounding image when the image display switch has been turned on. The processor is configured to stop displaying the surrounding image when a vehicle speed of the vehicle has become equal to or higher than a first threshold while the rough-road travel support control is deselected. The processor is configured to, while the rough-road travel support control is executed, temporarily stop displaying the surrounding image when the vehicle speed has become equal to or higher than the first threshold, and resume displaying the surrounding image, which has been temporarily stopped, when the vehicle speed has become lower than a second threshold that is smaller than the first threshold.

### BRIEF DESCRIPTION OF DRAWINGS

FIG. 1 is a schematic configuration diagram of an image display device mounted on a vehicle.

FIG. 2 is a plan view illustrating an example of an information display and various operation switches.

FIG. 3 is a plan view illustrating attachment positions of a vehicle-mounted camera and an information display.

FIG. 4 is a flowchart (part 1) presenting an image display operation determination routine according to a rough-road travel support control state.

FIG. 5 is a flowchart (part 2) presenting the image display operation determination routine according to the rough-road travel support control state.

FIG. 6 is a flowchart (part 3) presenting the image display operation determination routine according to the rough-road travel support control state.

### DESCRIPTION OF EMBODIMENTS

Hereinafter, an embodiment of one aspect of the present invention will be described in detail with reference to the drawings. In the drawings used for the following description, the scale of each component is different in order to make each component have a size that can be recognized in the drawings. Thus, the present invention is not limited in terms of the number of components, the shapes of the components, the ratios of the sizes of the components, and the relative positional relationship of the components illustrated in these drawings.

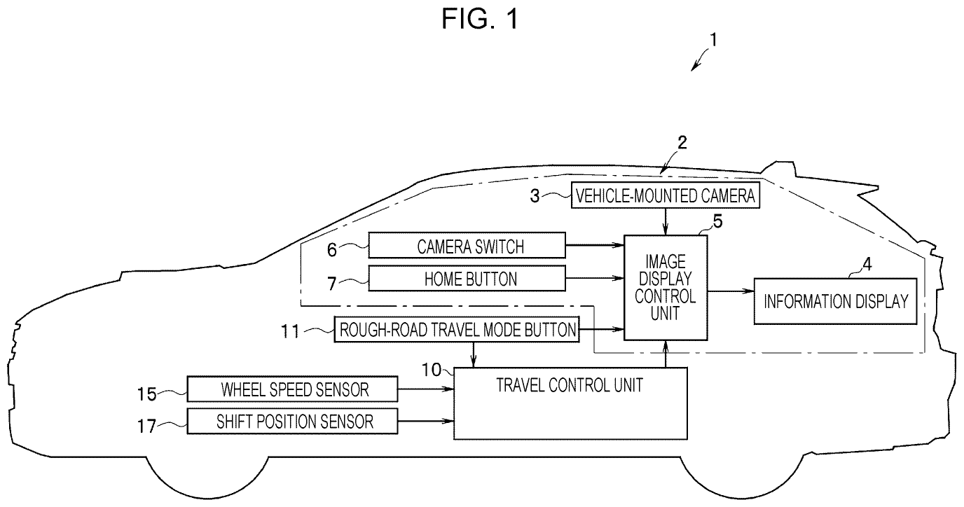

As illustrated in FIG. 1, as an example of an image display device to be applied to a vehicle 1 such as an automobile, a configuration of a vehicle-use image display device 2 having a function of causing a display in the vehicle to display an image (surrounding image) obtained by capturing an image of the surroundings of the vehicle 1 will be described.

The vehicle-use image display device 2 of the present embodiment is applied to the vehicle 1 including a travel control unit 10 capable of executing rough-road travel support control. The vehicle-use image display device 2 changes a display control mode of the surrounding image to be displayed on the display in accordance with an execution state of the rough-road travel support control.

Thus, prior to the description of the vehicle-use image display device 2, the rough-road travel support control by the travel control unit 10 will be briefly described.

For example, a rough-road travel mode button 11, a wheel speed sensor 15, and a shift position sensor 17 are coupled to the input side of the travel control unit 10.

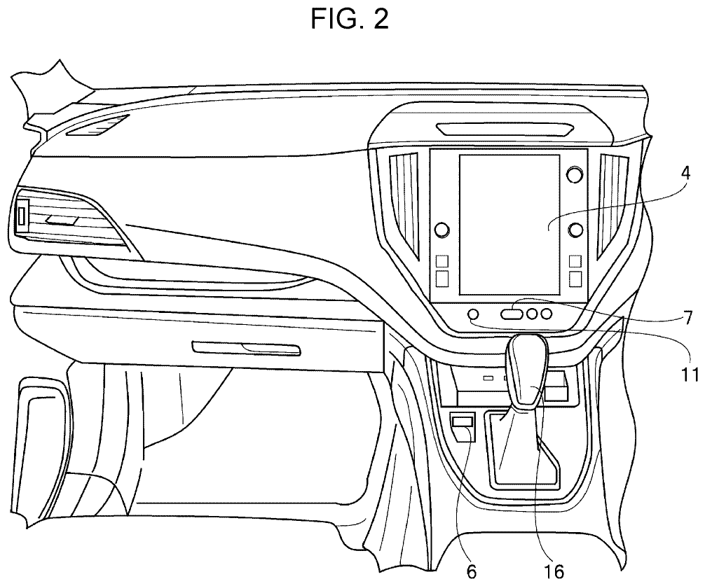

As illustrated in FIG. 2, the rough-road travel mode button 11 is provided, for example, near the center of an instrument panel (not illustrated) that can be operated by a driver. The rough-road travel mode button 11 is a button for switching from normal travel control to the rough-road travel support control based on an operation input of the driver when the vehicle 1 travels on a rough road such as a snowy road, a gravel road, or a muddy road. In the present embodiment, the normal travel control is, for example, control for performing driving-force distribution control, braking-force distribution control, and the like suitable for traveling on a high u road such as a paved road. In contrast, the rough-road travel support control is, for example, control for performing the driving-force distribution control, the braking-force distribution control, and the like suitable for traveling on a rough road such as a snowy road, a gravel road, or a muddy road. The rough-road travel mode button 11 is coupled to the travel control unit 10, and is also coupled to the image display control unit 5 (described later).

The wheel speed sensor 15 is a sensor that detects the wheel speed of each of multiple wheels (for example, four wheels) of the vehicle 1. Thus, the travel control unit 10 individually detects, for example, a locked state, an idling state, or the like of each wheel using the wheel speed detected by the corresponding wheel speed sensor 15. The travel control unit 10 can also calculate a vehicle speed Vs of the vehicle 1 based on the average value of the wheel speeds. The travel control unit 10 can also calculate the vehicle speed Vs based on, for example, an output signal from a rotational speed sensor for detecting the rotational speed of an output shaft of a transmission (not illustrated).

The shift position sensor 17 is, for example, a sensor that detects a shift position when a shift lever 16 is operated by a user (see FIG. 2).

Thus, the shift position sensor 17 detects a shift position such as a forward travel range (D range or the like), a parking range (P range or the like), or a reverse travel range (R range) in the operation with the shift lever 16.

In response to that the driver turns on the rough-road travel mode button 11 while the vehicle 1 travels at the vehicle speed Vs lower than a set vehicle speed, the travel control unit 10 switches the travel mode of the vehicle 1 from the normal travel control to the rough-road travel support control.

For example, when the forward travel range or the reverse travel range has been detected by the shift position sensor 17, the travel control unit 10 switches the travel mode from the normal travel control to the rough-road travel support control on condition that the rough-road travel mode button 11 has been turned on while the vehicle 1 travels at the vehicle speed Vs lower than a set vehicle speed Vset1 (for example, 20 km/h). When the vehicle speed Vs exceeds a predetermined vehicle speed (for example, 40 km/h), the travel control unit 10 deselects the rough-road travel support control.

In response to that the rough-road travel support control is started, the travel control unit 10 performs integration control on an engine, a transmission, a differential device, a brake, and the like. Accordingly, the travel control unit 10 appropriately controls the driving force, the braking force, and the like of the four wheels, and provides smooth exit from the rough road.

For example, the travel control unit 10 performs torque distribution with emphasis on the rear wheels by engagement control on a hydraulic multi-plate clutch of a center differential device (not illustrated). In addition, for example, when an idling wheel is detected based on a signal from the wheel speed sensor 15, the travel control unit 10 applies a braking force to the idling wheel by brake control to suppress the idling of the wheel.

The travel control unit 10 that performs such rough-road travel support control outputs execution information on the rough-road travel support control to the image display device 2.

As illustrated in FIG. 1, the image display device 2 includes a vehicle-mounted camera 3, an information display 4, and an image display control unit 5.

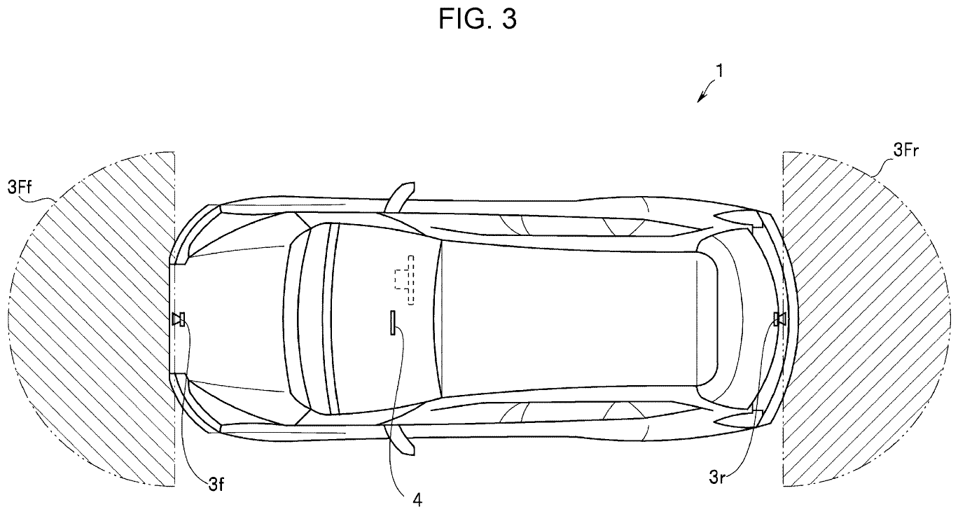

As illustrated in FIG. 3, the vehicle-mounted camera 3 includes a front camera 3f and a rear camera 3r.

Each of the cameras 3f and 3r includes a wide-angle lens capable of wide-angle imaging, an image sensor, and the like. The cameras 3f and 3r capture images of different ranges of the surroundings of the vehicle 1.

For example, the cameras 3f and 3r capture images of the range of a field of view 3Ff and the range of a field of view 3Fr (for example, each range having an angle of view of 180°) that are blind spots of the driver in front of the vehicle body or in rear of the vehicle body.

Thus, the front camera 3f is attached to, for example, a predetermined position such as a front grille to be able to capture an image of a blind spot of the field of view 3Ff. The rear camera 3r is attached to, for example, a predetermined position near a rear license plate to be able to capture an image of a blind spot of the field of view 3Fr.

In the present embodiment, the vehicle-mounted camera 3 (the front camera 3f and the rear camera 3r) corresponds to an example of an image-capturing unit (image-capturing module).

As illustrated in FIG. 1, the surrounding images of the vehicle 1 captured by the cameras 3f and 3r are output to the image display control unit 5.

As illustrated in FIG. 2, the information display 4 is provided, for example, near the center of the instrument panel (not illustrated).

The information display 4 displays, for example, a surrounding image captured by the vehicle-mounted camera 3 or information for changing settings of the vehicle 1.

In the present embodiment, the information display 4 corresponds to an example of an image display (image display module).

The image display control unit 5 serves as an image display controller that causes the information display 4 to display each of the captured surrounding images of the vehicle 1 based on an operation instruction of the driver.

Thus, a camera switch 6 and a home button 7 that are operated by the driver are coupled to the input side of the image display control unit 5.

As illustrated in FIG. 2, the camera switch 6 is provided as an image display switch, for example, near the shift lever 16 that can be operated by the driver. The camera switch 6 serves as an on/off switch that causes the information display 4 to display the surrounding image captured by the vehicle-mounted camera 3.

As illustrated in FIG. 2, the home button 7 is disposed near the information display 4 together with the rough-road travel mode button 11 and the like. The home button 7 is, for example, operated by the driver to stop displaying various kinds of activated application software and cause the information display 4 to display a home screen. Thus, for example, even in a case where the surrounding image captured by the vehicle-mounted camera 3 is being displayed on the information display 4, in response to that the driver turns on the home button 7, the display of the surrounding image is stopped and the home screen is displayed.

The home screen is, for example, a standby screen on which icons of various kinds of application software are arranged. Alternatively, the information display 4 may be constituted by, for example, a touch panel display. The home button 7, the rough-road travel mode button 11, and the like may be displayed on the information display 4.

The image display control unit 5 causes the information display 4 to display the surrounding image in accordance with the operation of the driver and the execution state of the rough-road travel support control.

To display the surrounding image, the image display control unit 5 changes the display control mode of the surrounding image to be displayed on the information display 4.

For example, the image display control unit 5 has a first display control mode and a second display control mode as the display control mode. The first display control mode and the second display control mode are selected in accordance with the execution state of the rough-road travel support control.

The first display control mode is started in response to that the camera switch 6 is turned on by the driver when the rough-road travel support control has not been executed (when the normal travel control has been executed). In response to that the first display control mode is started, the image display control unit 5 causes the information display 4 to display a surrounding image corresponding to the shift position of the shift lever 16.

That is, when the forward travel range has been selected as the shift position, the image display control unit 5 causes the information display 4 to display a surrounding image captured by the front camera 3f. However, when the vehicle speed Vs has become equal to or higher than the set vehicle speed Vset1 (for example, 20 km/h), the image display control unit 5 stops displaying the surrounding image captured by the front camera 3f.

When the reverse travel range has been selected as the shift position, the image display control unit 5 causes the information display 4 to display a surrounding image captured by the rear camera 3r.

The second display control mode is basically started in conjunction with the start of the rough-road travel support control. Thus, when the rough-road travel support control has been started, the second display control mode is started without the turn-on operation on the camera switch 6 by the driver. In response to that the second display control mode is started, the image display control unit 5 causes the information display 4 to display a surrounding image corresponding to the shift position of the shift lever 16.

That is, when the forward travel range has been selected as the shift position, the image display control unit 5 causes the information display 4 to display a surrounding image captured by the front camera 3f. However, when the vehicle speed Vs has become equal to or higher than the set vehicle speed Vset1 (for example, 20 km/h), the image display control unit 5 temporarily stops displaying the surrounding image captured by the front camera 3f. Further, when the vehicle speed Vs has become lower than a set vehicle speed Vset2 (for example, 15 km/h) that is lower than the set vehicle speed Vset1, the image display control unit 5 automatically resumes displaying the surrounding image, which has been temporarily stopped.

When the reverse travel range has been selected as the shift position, the image display control unit 5 causes the information display 4 to display a surrounding image captured by the rear camera 3r.

When the rough-road travel mode button 11 has been turned on (the rough-road travel support control is executed) while the first display control mode is executed, the image display control unit 5 switches the display control mode from the first display control mode to the second display control mode in conjunction with the execution of the rough-road travel support control.

When the rough-road travel support control has been deselected while the second display control mode is executed or while the second display control mode is temporarily stopped, the image display control unit 5 stops the second display control mode in conjunction with the deselection of the rough-road travel support control.

In the present embodiment, the set vehicle speed Vset1 corresponds to an example of a first threshold. The set vehicle speed Vset2 corresponds to an example of a second threshold.

In the present embodiment, the image display control unit 5 corresponds to an example of an image display controller.

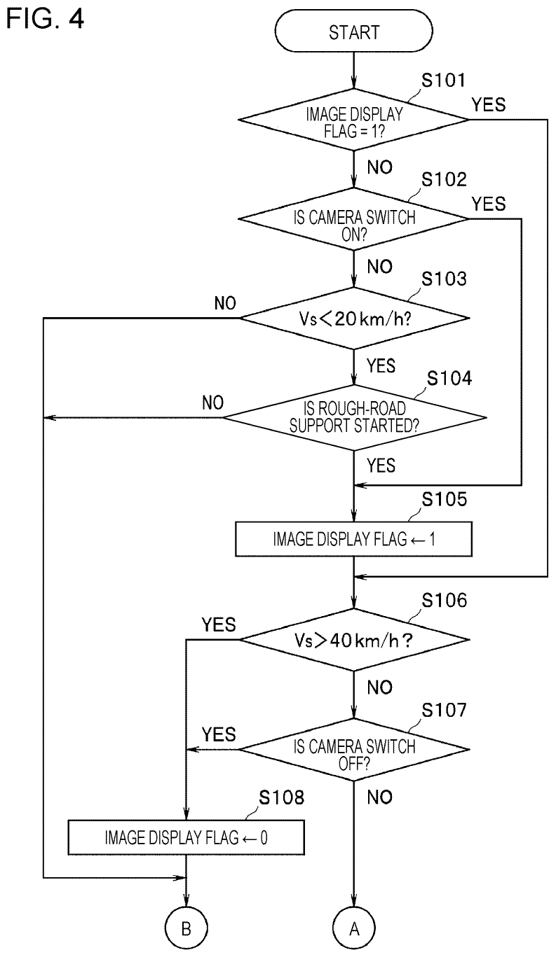

Next, a display operation of the surrounding image of the vehicle 1 according to the rough-road travel support control state executed by the image display control unit 5 of the present embodiment will be described with reference to the flowchart of an image display operation determination routine presented in FIGS. 4, 5, and 6. This routine is repeatedly executed at set time intervals.

As presented in FIG. 4, when the routine starts, the image display control unit 5 first determines whether 1 has been set to an image display flag in step S101. The image display flag is used for identification when the surrounding image is displayed. Thus, the image display flag is set to 1 when the surrounding image is displayed on the information display 4 based on the operation of the driver.

In step S101, when it has been determined that 1 has been set to the image display flag (step S101: YES), the image display control unit 5 proceeds to step S106 (described later).

In contrast, in step S101, when it has been determined that 1 has not been set to the image display flag (step S101: NO), the image display control unit 5 proceeds to step S102.

In step S102, the image display control unit 5 determines whether the camera switch 6 has been turned on.

In step S102, when it has been determined that the camera switch 6 has been turned on (step S102: YES), the image display control unit 5 proceeds to step S105 (described later).

In contrast, in step S102, when it has been determined that the camera switch 6 has not been turned on (step S102: NO), the image display control unit 5 proceeds to step S103.

In step S103, the image display control unit 5 determines whether the vehicle speed Vs is lower than the set vehicle speed Vset1 (for example, 20 km/h).

In step S103, when it has been determined that the vehicle speed Vs is equal to or higher than the set vehicle speed Vset1 (for example, 20 km/h) (step S103: NO), the image display control unit 5 proceeds to step S117 (described later).

In contrast, in step S103, when it has been determined that the vehicle speed Vs is lower than the set vehicle speed Vset1 (for example, 20 km/h) (step S103: YES), the image display control unit 5 proceeds to step S104.

In step S104, the image display control unit 5 determines whether the rough-road travel support control has been started.

In step S104, when it has been determined that the rough-road travel support control has not been started (first display control mode) (step S104: NO), the image display control unit 5 proceeds to step S117 (described later).

In contrast, in step S104, when it has been determined that the rough-road travel support control has been started (second display control mode) (step S104: YES), the image display control unit 5 proceeds to step S105.

When the process proceeds from step S102 or step S104 to step S105, the image display control unit 5 sets 1 to the image display flag, and then proceeds to step S106.

When the process proceeds from step S101 or step S105 to step S106, the image display control unit 5 determines whether the vehicle speed Vs is higher than 40 km/h.

In step S106, when it has been determined that the vehicle speed Vs is higher than 40 km/h (step S106: YES), the image display control unit 5 proceeds to step S108 (described later). In this case, the image display control unit 5 deselects the rough-road travel support control (first display control mode).

In contrast, in step S106, when it has been determined that the vehicle speed Vs is equal to or lower than 40 km/h (step S106: NO), the image display control unit 5 proceeds to step S107.

In step S107, the image display control unit 5 determines whether the camera switch 6 has been turned off.

In step S107, when it has been determined that the camera switch 6 has been turned off (step S107: YES), the image display control unit 5 proceeds to step S108.

When the process proceeds from step S106 or step S107 to step S108, the image display control unit 5 clears the image display flag to 0, and then proceeds to step S117 (described later).

In contrast, in step S107, when it has been determined that the camera switch 6 has not been turned off (step S107: NO), the image display control unit 5 proceeds to step S109.

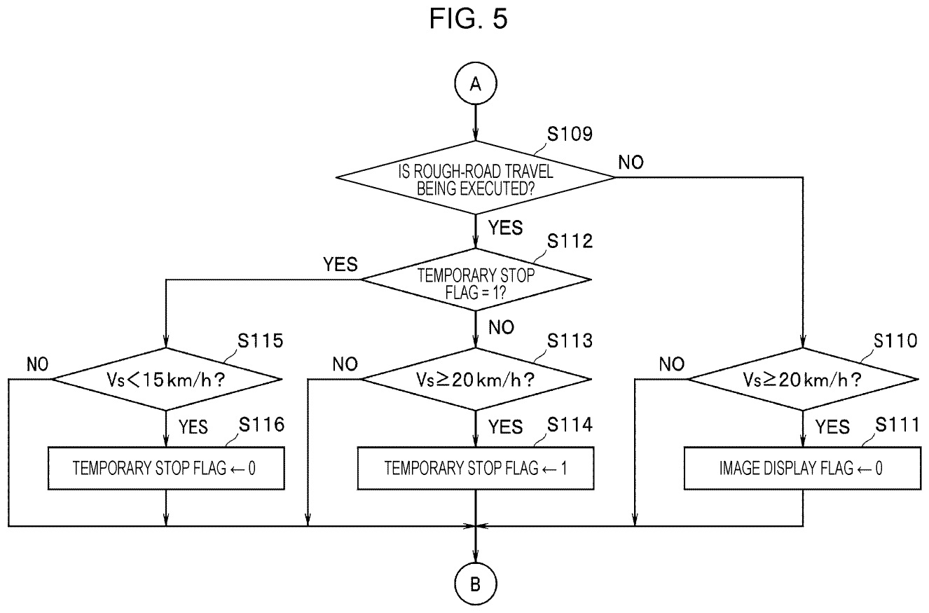

In step S109, as presented in FIG. 5, the image display control unit 5 determines whether the rough-road travel support control is being executed.

In step S109, when it has been determined that the rough-road travel support control is being executed (second display control mode) (step S109: YES), the image display control unit 5 proceeds to step S112 (described later).

In contrast, in step S109, when it has been determined that the rough-road travel support control is not being executed (first display control mode) (step S109: NO), the image display control unit 5 proceeds to step S110.

In step S110, the image display control unit 5 determines whether the vehicle speed Vs is equal to or higher than the set vehicle speed Vset1 (for example, 20 km/h).

In step S110, when it has been determined that the vehicle speed Vs is lower than the set vehicle speed Vset1 (for example, 20 km/h) (step S110: NO), the image display control unit 5 proceeds to step S117 (described later).

In contrast, in step S110, when it has been determined that the vehicle speed Vs is equal to or higher than the set vehicle speed Vset1 (for example, 20 km/h) (step S110: YES), the image display control unit 5 proceeds to step S111.

In step S111, the image display control unit 5 clears the image display flag to 0, and then proceeds to step S117 (described later).

When the process proceeds from step S109 to step S112, the image display control unit 5 determines whether 1 has been set to a temporary stop flag. The temporary stop flag is used for identification when the display of the surrounding image is temporarily stopped in the second display control mode. Thus, the temporary stop flag is set to 1 when the display of the surrounding image on the information display 4 is temporarily stopped based on the operation of the driver.

In step S112, when it has been determined that 1 has been set to the temporary stop flag (step S112: YES), the image display control unit 5 proceeds to step S115 (described later).

In contrast, in step S112, when it has been determined that 1 has not been set to the temporary stop flag (step S112: NO), the image display control unit 5 proceeds to step S113.

In step S113, the image display control unit 5 determines whether the vehicle speed Vs is equal to or higher than the set vehicle speed Vset1 (for example, 20 km/h).

In step S113, when it has been determined that the vehicle speed Vs is lower than the set vehicle speed Vset1 (for example, 20 km/h) (step S113: NO), the image display control unit 5 proceeds to step S117 (described later).

In contrast, in step S113, when it has been determined that the vehicle speed Vs is equal to or higher than the set vehicle speed Vset1 (for example, 20 km/h) (step S113: YES), the image display control unit 5 proceeds to step S114.

In step S114, the image display control unit 5 sets 1 to the temporary stop flag, and then proceeds to step S117 (described later).

When the process proceeds from step S112 to step S115, the image display control unit 5 determines whether the vehicle speed Vs is lower than the set vehicle speed Vset2 (for example, 15 km/h).

In step S115, when it has been determined that the vehicle speed Vs is equal to or higher than the set vehicle speed Vset2 (for example, 15 km/h) (step S115: NO), the image display control unit 5 proceeds to step S117 (described later).

In contrast, in step S115, when it has been determined that the vehicle speed Vs is lower than the set vehicle speed Vset2 (for example, 15 km/h) (step S115: YES), the image display control unit 5 proceeds to step S116.

When the process proceeds to step S116, the image display control unit 5 clears the temporary stop flag to 0, and then proceeds to step S117 (described later).

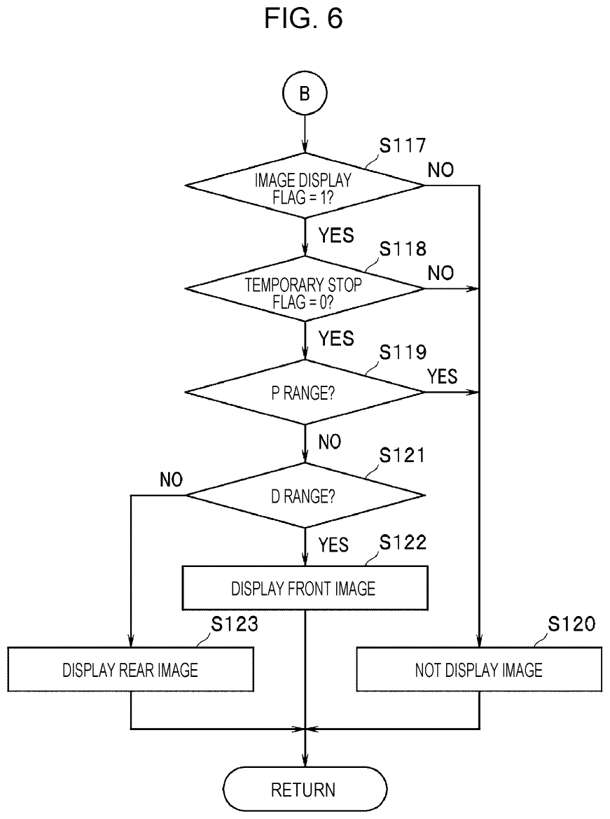

Then, when the process proceeds from step S103, step S104, step S108, step S110, step S111, step S113, step S114, step S115, or step S116 to step S117, the image display control unit 5 determines whether 1 has been set to the image display flag, as presented in FIG. 6.

In step S117, when it has been determined that 1 has not been set to the image display flag (step S117: NO), the image display control unit 5 proceeds to step S120 (described later).

In contrast, in step S117, when it has been determined that 1 has been set to the image display flag (step S117: YES), the image display control unit 5 proceeds to step S118.

In step S118, the image display control unit 5 determines whether the temporary stop flag has been cleared to 0.

In step S118, when it has been determined that the temporary stop flag has not been cleared to 0 (step S118: NO), the image display control unit 5 proceeds to step S120 (described later).

In contrast, in step S118, when it has been determined that the temporary stop flag has been cleared to 0 (step S118: YES), the image display control unit 5 proceeds to step S119.

In step S119, the image display control unit 5 determines whether the shift position detected by the shift position sensor 17 is the parking range (P range or the like).

In step S119, when it has been determined that the shift position is not the parking range (P range or the like) (step S119: NO), the image display control unit 5 proceeds to step S121 (described later).

In contrast, in step S119, when it has been determined that the shift position is the parking range (P range or the like) (step S119: YES), the image display control unit 5 proceeds to step S120.

Then, when the process proceeds from step S117, step S118, or step S119 to step S120, the image display control unit 5 does not display the surrounding image and then exits the routine.

When the process proceeds from step S119 to step S121, the image display control unit 5 determines whether the shift position is the forward travel range (D range or the like).

In step S121, when it has been determined that the shift position is the forward travel range (D range or the like) (step S121: YES), the image display control unit 5 proceeds to step S122.

When the process proceeds to step S S122, the image display control unit 5 displays a front surrounding image captured by the front camera 3f, and then exits the routine.

In contrast, in step S121, when it has been determined that the shift position is not the forward travel range (D range or the like) (step S121: NO), the image display control unit 5 proceeds to step S123.

When the process proceeds to step S123, the image display control unit 5 determines that the shift position is the reverse travel range (R range), displays a rear surrounding image captured by the rear camera 3r, and then exits the routine.

According to such an embodiment, a vehicle-use image display device 2 is applied to a vehicle 1 capable of executing rough-road travel support control. The vehicle-use image display device 2 includes a vehicle-mounted camera 3 configured to capture a surrounding image of surroundings of the vehicle 1; an information display 4 for displaying the surrounding image captured by the vehicle-mounted camera 3; a camera switch 6 configured to instruct displaying the surrounding image; and an image display control unit 5 configured to cause the information display 4 to display the surrounding image when the camera switch 6 has been turned on. The image display control unit 5 has a first display control mode when the rough-road travel support control is deselected and a second display control mode when the rough-road travel support control is executed. While the first display control mode is executed, the image display control unit 5 stops displaying the surrounding image when a vehicle speed Vs of the vehicle 1 has become equal to or higher than a first threshold (Vset1). While the second display control mode is executed, the image display control unit 5 temporarily stops displaying the surrounding image when the vehicle speed Vs has become equal to or higher than the first threshold (Vset1), and resumes displaying the surrounding image, which has been temporarily stopped, when the vehicle speed Vs has become lower than a second threshold (Vset2) that is smaller than the first threshold (Vset1).

With these configurations, the vehicle-use image display device 2 can provide convenience and safety even in the case where the vehicle speed Vs changes when the vehicle 1 travels on a rough road.

That is, in the first display control mode, when the vehicle speed Vs has become equal to or higher than the first threshold (for example, 20 km/h), the image display control unit 5 stops displaying the surrounding image, which has been displayed until then. That is, in the normal travel control in which the vehicle speed Vs less changes, the image display control unit 5 automatically turns off the surrounding image based on the vehicle speed Vs. Thus, the image display control unit 5 can reduce the complicated operation of the driver.

In the second display control mode, when the vehicle speed Vs has become equal to or higher than the first threshold (for example, 20 km/h), the image display control unit 5 temporarily stops displaying the surrounding image. Further, when the vehicle speed Vs has become lower than the second threshold (for example, 15 km/h), the image display control unit 5 automatically resumes displaying the surrounding image, which has been temporarily stopped. Accordingly, in the rough-road travel support control in which the vehicle speed Vs is likely to greatly change, even in the case where the vehicle speed Vs has changed, the image display control unit 5 can automatically turn on/off the display of the surrounding image within a predetermined vehicle speed range (for example, 40 km/h or lower). Thus, the image display control unit 5 can further reduce the complicated operation of the driver.

The second threshold is set to be smaller than the first threshold. Accordingly, the image display control unit 5 can suppress hunting when the display of the surrounding image is automatically turned on/off based on the change in the vehicle speed Vs. Thus, the image display control unit 5 can provide a display switching operation that does not give a sense of discomfort to the driver.

In addition, in response to that the rough-road travel mode button 11 is turned on when the vehicle speed Vs is lower than the first threshold (for example, 20 km/h), the image display control unit 5 starts the second display control mode in conjunction with the turn-on operation (the start of the rough-road travel support control). Accordingly, when the image display control unit 5 displays the surrounding image during the rough-road travel support control, the operation of the camera switch 6 that is operated by the driver can be omitted. Thus, the image display control unit 5 can further reduce the complicated operation of the driver.

When the rough-road travel mode button 11 has been turned on (the rough-road travel support control has been executed) while the first display control mode is executed, the image display control unit 5 switches the display control mode from the first display control mode to the second display control mode in conjunction with the execution of the rough-road travel support control. Accordingly, even after switching to the rough-road travel support control, the image display control unit 5 can cause the information display 4 to display the surrounding image displayed during the normal travel control as it is. Thus, the image display control unit 5 can improve convenience when the driver switches the control from the normal travel control to the rough-road travel support control.

When the rough-road travel support control has been deselected while the second display control mode is executed or while the second display control mode is temporarily stopped, the image display control unit 5 stops the second display control mode in conjunction with the deselection of the rough-road travel support control. Accordingly, the image display control unit 5 can suppress unnecessary display on the information display 4. Thus, the image display control unit 5 can provide appropriate display that matches the intention of the driver.

In the present embodiment, the front camera 3f and the rear camera 3r have been described as an example of the configuration of the vehicle-mounted camera 3, but a pair of left and right side cameras capable of capturing images of ranges that are blind spots on the lateral sides of the vehicle body may be provided. In this case, a bird's-eye view image using the surrounding images of the lateral sides of the vehicle 1 or the surrounding images of the multiple cameras (the front camera 3f, the rear camera 3r, and the pair of side cameras) may be displayed on the information display 4. That is, in the present embodiment, as an example of the image to be displayed on the information display 4, the surrounding images of the ranges in front and rear of the vehicle 1 have been described. However, various images such as surrounding images of the lateral sides of the vehicle 1 and a bird's-eye view image can be appropriately displayed.

In the above-described embodiment, the image display control unit 5, the travel control unit 10, and the like are constituted by a known microcomputer including a CPU, a RAM, a ROM, a nonvolatile memory, and the like, and peripheral devices thereof. The ROM stores in advance fixed data and the like such as programs executed by the CPU and data tables. All or some of the functions of a processor may be constituted by a logic circuit or an analog circuit, and processes of various programs may be implemented by an electronic circuit such as an FPGA.

The invention described in the above-described embodiment is not limited to the embodiment, and various modifications can be made within the scope not departing from the gist of the invention in the phase of the implementation. Furthermore, the above-described embodiment includes inventions at various stages, and various inventions can be extracted by appropriately combining disclosed multiple components.

Even when some components are removed from all the components described in the above-described embodiment, the configuration from which the components have been removed can be extracted as an invention as long as the described problems can be solved, and the described effects can be obtained.

1. A vehicle-use image display device to be applied to a vehicle capable of executing rough-road travel support control by one or both of driving-force distribution control on wheels and braking-force distribution control on the wheels, the vehicle-use image display device comprising:
an image-capturing unit configured to capture a surrounding image of surroundings of the vehicle;
an image display configured to display the surrounding image captured by the image-capturing unit;
an image display switch configured to instruct displaying the surrounding image; and
an image display controller configured to cause the image display to display the surrounding image when the image display switch has been turned on,
wherein the image display controller has, as a display control mode, a first display control mode when the rough-road travel support control is deselected and a second display control mode when the rough-road travel support control is executed,
wherein the image display controller is configured to, while the first display control mode is executed, stop displaying the surrounding image when a vehicle speed of the vehicle has become equal to or higher than a first threshold, and
wherein the image display controller is configured to, while the second display control mode is executed, temporarily stop displaying the surrounding image when the vehicle speed has become equal to or higher than the first threshold, and resume displaying the surrounding image, which has been temporarily stopped, when the vehicle speed has become lower than a second threshold that is smaller than the first threshold.

2. The vehicle-use image display device according to claim 1, wherein the image display controller is configured to, when the rough-road travel support control has been executed while the first display control mode is executed, switch the display control mode from the first display control mode to the second display control mode in conjunction with that the rough-road travel support control has been executed.

3. The vehicle-use image display device according to claim 1, wherein the image display controller is configured to, when the rough-road travel support control has been deselected while the second display control mode is executed or while the second display control mode is temporarily stopped, stop the second display control mode in conjunction with that the rough-road travel support control has been deselected.

4. The vehicle-use image display device according to claim 1, wherein the image display controller is configured to, in response to the rough-road travel support control being started when the vehicle speed is lower than the first threshold, start the second display control mode in conjunction with the rough-road travel support control being started.

5. The vehicle-use image display device according to claim 1, wherein, in the first display control mode and the second display control mode, the surrounding image displayed on the image display is the surrounding image captured by the same image-capturing unit.

6. A vehicle-use image display device to be applied to a vehicle capable of executing rough-road travel support control by one or both of driving-force distribution control on wheels and braking-force distribution control on the wheels, the vehicle-use image display device comprising:
an image-capturing module configured to capture a surrounding image of surroundings of the vehicle;
an image display module configured to display the surrounding image captured by the image-capturing module;
an image display switch configured to instruct displaying the surrounding image; and
a processor configured to cause the image display module to display the surrounding image when the image display switch has been turned on,
wherein the processor is configured to stop displaying the surrounding image when a vehicle speed of the vehicle has become equal to or higher than a first threshold while the rough-road travel support control is deselected, and
wherein the processor is configured to, while the rough-road travel support control is executed, temporarily stop displaying the surrounding image when the vehicle speed has become equal to or higher than the first threshold, and resume displaying the surrounding image, which has been temporarily stopped, when the vehicle speed has become lower than a second threshold that is smaller than the first threshold.
